(19) United States
(12) Patent Application Publication
(10) Pub. No.: US 2026/0192721 A1
(43) Pub. Date: Jul. 9, 2026

(54) SUPPORT INCLINATION DEVICE, SEAT PART, AND VEHICLE SEAT

(71) Applicant: Adient US LLC, Plymouth, MI (US)

(72) Inventors: Tobias EWALD, Huckenswagen (DE); Martin KONAK, Sklabina pri Martine (SK); Michal ANDO, Trencin (SK)

(21) Appl. No.: 19/442,001

(22) Filed: Jan. 7, 2026

(30) Foreign Application Priority Data
Jan. 7, 2025 (DE) 10 2025 100 328.9
Jun. 17, 2025 (DE) 10 2025 123 581.3

(51) Int. Cl. B60N 2/68; B60N 2/02; B60N 2/64

(52) U.S. Cl. CPC B60N 2/68; B60N 2/02246; B60N 2/64

(57) ABSTRACT

A support inclination device for a seat face of a vehicle seat may have a drive unit and a support which is bent multiple times and is designed as an inclination support, the latter on one side being rotatably mounted without play, and on the other side being rotatably mounted with play on a bracket and by way of the bracket being coupled to the drive unit for inclination adjustment. A seat part and a vehicle seat with the device are also provided.

### FIELD

The invention relates to a support inclination device, in particular a tiltable leg support device and/or tiltable thigh support device, in particular a tiltable femur support device, for a seat part of a vehicle seat, and to a vehicle seat.

### BACKGROUND

Support devices, in particular leg support devices, for example adjustable thigh support devices, are generally known. For example, a vehicle seat having a seat depth adjustment is known from DE 20 2019 104 366 U1.

The invention is based on the object of improving a support inclination device of the type mentioned at the outset, in particular to provide a particularly simply constructed support inclination device, a corresponding seat part and a corresponding vehicle seat.

### SUMMARY

The objects mentioned are achieved according to the invention by a support inclination device, a seat part, and by a vehicle seat having the features of the claims.

The support inclination device according to the invention (also referred to as support device or inclination device for short) for a seat part of a vehicle seat comprises a drive unit and a support which is bent multiple times and is designed as an inclination support, the latter, on the one hand, being mounted so as to be rotatable about a first rotation axis and without play and, on the one hand, being mounted so as to be rotatable about a second rotation axis and with play on a bracket and by way of the bracket being coupled to the drive unit for inclination adjustment.

The inclination support is understood to mean in particular a support which is automatically adjustable for inclination by the drive unit. For example, the support tilts while driven by the drive unit, and by virtue of the play enables relative movements, thus additionally compensating for tolerances. In particular, the inclination support is mounted on the bracket so as to be longitudinally movable in a restricted manner by the play.

For example, the support is designed as a wire multi-bend support or as a tubular multi-bend support. In particular, the support is designed to be flexible and/or movable, in particular rotatable, in at least one spatial direction. This enables in a simple manner a tilting function or inclination function for the support inclination device without additional adjustment elements. In particular, the driven support enables an automatic variation of an angle of inclination of the support inclination device.

For example, the inclination support can be specified in such a manner that the latter in terms of inclination is adjustable by a predefined inclination angle in a range from, for example >0° to <10°, in particular >0° to <5° or >0° to <3°, relative to a horizontal.

For example, the inclination support can be designed as a wire support which is formed from at least one bent wire material or a bent strip material. In particular, the wire support can be designed as an integral continuous wire which is bent multiple times, or as an integral continuous strip which is bent multiple times.

Alternatively or additionally, the inclination support can be designed as, for example, a tubular support which is formed from at least one bent tubular material. In particular, the tubular support can be designed as an integral continuous tube which is bent multiple times.

In another alternative, the inclination support can be designed in multiple parts. For example, the inclination support can be formed from a first bent sub-support (also referred to as support part) and from a second bent sub-support (also referred to as support part). These sub-supports can be formed separately. Furthermore, they may be connected to one another.

The second object mentioned is moreover achieved according to the invention by a seat part having a seat frame (also referred to as seat face frame) and by the support inclination device fastened thereto.

For example, the seat face frame comprises two frame sides, in particular longitudinal frames. The inclination support is preferably disposed between these two frame sides and fastened to the latter so as to be tiltable and/or longitudinally movable in a restricted manner.

The third object mentioned is moreover achieved according to the invention by a vehicle seat having the aforementioned support inclination device.

Owing to the fact that the support inclination device is designed as a multi-bend support, in particular as a wire multi-bend support or as a tubular multi-bend support, a particularly simply constructed support with sufficient strength for use as a rest, for example a leg rest or thigh rest of a user of a vehicle seat, with an integrated tilting function is possible.

Moreover, such a multi-bend support enables a simple interface with a seat cushion and/or with a seat cover of the vehicle seat. Furthermore, the multi-bend support can be designed to be flexible and/or compensate for tolerances in at least one spatial direction. For example, the support can at one end be mounted on the bracket so as to be rotatable with play. As a result, the multi-bend support can move up and down so as to compensate for tolerances while being driven by the drive unit. Moreover, no complex and cost-intensive tools, such as presses, are required for production and/or assembly. Furthermore, such a support is particularly light and has a low weight.

The drive unit is in particular designed as a linear drive, for example a spindle drive.

The spindle drive comprises, for example, a motor and a spindle. The spindle is mounted so as to be rotatable about a third rotation axis on the seat part or on a holder which is fixedly connected to the seat part, in particular welded thereto. The motor is fastened to a bracket which in turn is fixedly connected, in particular welded, to a transmission element which is mounted so as to be rotatable about a fourth rotation axis on the seat part.

In summary and in other words, the invention replaces the conventional seat shell with a support, in particular a tubular support or a wire support, which is bent multiple times and is at least in regions designed or mounted to be flexible or with play in particular in one spatial direction, so as to provide a tilting function in a simple manner. The support is formed in a plane, for example. The support is in particular designed as a two-dimensional tubular support or a two-dimensional wire support.

The multi-bend support can be produced in a simple and cost-effective manner, for example by a bending method, in particular a so-called CNC bending method for tubes or wires. The use of complex tools is thus avoided.

The multi-bend support can be produced from a bent wire or a bent tube so as to be integral or in at least two parts, depending on the stiffness required.

The multi-bend support, designed as a tubular support or wire support, for example, can have a center of rotation, for example on a rear end, for assembling on a side skirt of a vehicle seat, and a tolerance-compensating center of rotation, in particular at a front end, for assembly on the bracket. Owing to such an in particular rear center of rotation of the support with a front tolerance-compensating center of rotation, easy compensation of tolerances and a relative movement in the longitudinal orientation, in particular toward the front and/or rear, is possible.

The multi-bend support can be easily adapted to different seat widths and/or seat lengths (also referred to as cushion widths and/or cushion lengths). Thus, the multi-bend support can be easily adapted to other applications. For example, for the various applications the support can comprise identical parts, such as a common interface, a common center of rotation, in particular bushes, step pins or the like, for interfaces/centers of rotation.

As a result, the multi-bend support can be adapted in an application-specific manner to different seat widths and/or seat lengths.

Moreover, the multi-bend support permits that one and the same seat cushion (also referred to as mat) and/or one and the same seat cover can be used in particular for 4/6-way tilting applications as well as for 8-way tilting applications, or tilting applications with more ways, of the support inclination device.

Moreover provided is a weight advantage due to the multi-bend support in comparison to the convention design of the shell. In particular, the multi-bend support also enables an improvement in shipping density due to a smaller packaging volume. Also, late design changes to the support inclination device are possible, because these only have a minor effect on the costs of tooling, since no large tools such as presses are required for producing the shell. Instead, only changes to the software, for example a CNC bending program, are required.

### DESCRIPTION OF THE FIGURES

The invention is described in more detail hereunder by way of advantageous exemplary embodiments illustrated in the figures. However, the invention is not limited to these exemplary embodiments. In the figures:

FIG. 1: shows a vehicle seat with a longitudinal adjustment unit in a schematic illustration,

FIG. 2: shows a seat part of the vehicle seat with a conventional support device (prior art) in a perspective illustration,

FIG. 3: shows a seat part with a support inclination device according to the invention, according to a first exemplar embodiment, in a perspective illustration,

FIG. 4: shows the support inclination device according to the first exemplary embodiment in an exploded illustration,

FIG. 5: shows the support inclination device according to the first exemplary embodiment with assembled attachment parts in a perspective illustration,

FIG. 6: shows the support inclination device according to FIG. 5 in top view,

FIG. 7: shows a seat part with a support inclination device according to the invention, according to a second exemplary embodiment, in a perspective illustration,

FIG. 8: shows an enlarged illustration of an interface of the support inclination device according to FIG. 7 on a seat part,

FIG. 9: shows the support inclination device according to the second exemplary embodiment in an exploded illustration,

FIG. 10: shows the support inclination device according to the second exemplary embodiment with assembled attachment parts in a perspective illustration,

FIG. 11: shows the support inclination device according to FIG. 10 in top view,

FIG. 12: shows the support inclination device according to the second exemplary embodiment, assembled on another seat part, in a perspective illustration,

FIG. 13: shows an enlarged fragment of the support inclination device in the region of the drive unit, and

FIG. 14: shows another enlarged fragment of the support inclination device in the region of the drive unit.

### DETAILED DESCRIPTION

Equivalent parts are provided with the same reference sign in all figures.

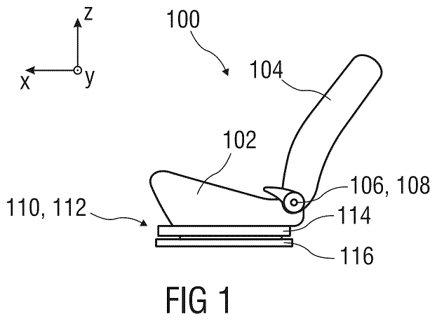

A vehicle seat 100 schematically illustrated in FIG. 1 for reference to the prior art will be described hereunder while using three mutually perpendicular spatial directions. In a vehicle seat 100 installed in the vehicle, a longitudinal direction x extends largely horizontally and preferably parallel to a vehicle longitudinal direction corresponding to the usual direction of travel of the vehicle. A transverse direction y, extending perpendicularly to the longitudinal direction x, is likewise aligned horizontally in the vehicle and extends parallel to a vehicle transverse direction. A vertical direction z extends perpendicularly to the longitudinal direction x and perpendicularly to the transverse direction y. In a vehicle seat 100 installed in the vehicle, the vertical direction z preferably extends parallel to a vehicle vertical axis.

The positional indicators and direction indicators used, such as front, rear, top and bottom refer to a direction of view of an occupant sitting in a normal sitting position in the vehicle seat 100, wherein the vehicle seat 100 is installed in the vehicle so as to be in a use position suitable for carrying passengers, with an upright backrest 104 and oriented as usual in the direction of travel. However, the vehicle seat 100 can also be installed or moved in a deviating orientation, for example transversely to the direction of travel. Unless otherwise described, the vehicle seat 100 is constructed so as to be mirror-symmetrical relative to a plane extending perpendicularly to the transverse direction y.

The backrest 104 can be pivotably disposed on a seat part 102 of the vehicle seat 100. For this purpose, the vehicle seat 100 can optionally comprise a fitting 106, in particular an adjustment fitting, rotary fitting, latching fitting or tumbler fitting.

The positional indicators and spatial indicators used, such as radial, axial and in the circumferential direction, refer to a rotation axis 108 of the fitting 106. Radial means perpendicular to the rotation axis 108. Axial means in the direction of, or parallel to, the rotation axis 108.

The vehicle seat 100 can optionally comprise a longitudinal adjustment unit 110. The longitudinal adjustment unit 110 comprises, for example, a rail assembly 112 having a first rail element 114 and a second rail element 116. The first rail element 114 is adjustable relative to the second rail element 116 in the longitudinal direction x. The first rail element 114 is fastened to the seat part 102. The second rail element 116 is fastened to a structural element of a vehicle, for example a vehicle floor.

For improved clarity, the first rail element 114 will be referred to as the upper rail 114 in the description hereunder. This upper rail 114 (also referred to as runner or slide) is assigned to the vehicle seat 100 and specified to carry this vehicle seat 100. The second rail element 116 will be referred to as the lower rail 116 hereunder. The lower rail 116 is fixed and connected to the floor of a vehicle, for example.

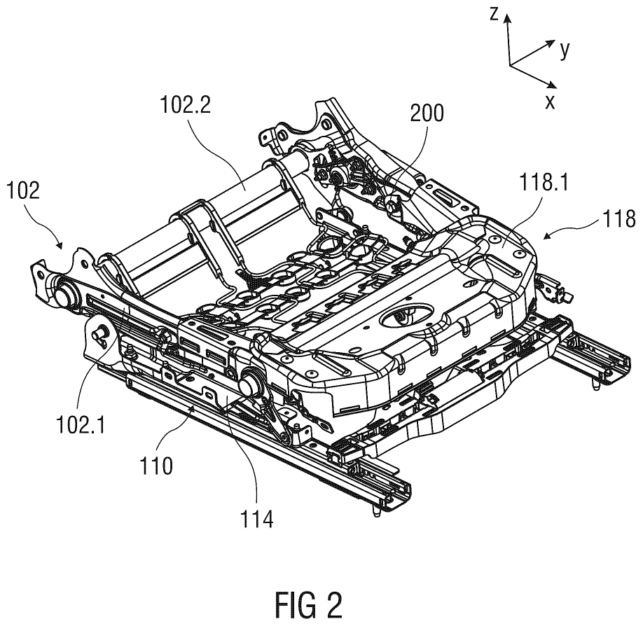

FIG. 2 shows in a perspective view an example of the seat part 102 of the vehicle seat 100 with a conventional support device 118 according to the prior art. The conventional support device 118 is designed as a support shell 118.1 which is mounted on the seat part 102 so as to be rotatable about a center of rotation 200.

The seat part 102 comprises a seat substructure 102.1 which is designed, for example, as a seat frame 102.2, as illustrated. Alternatively (not illustrated in more detail), the seat substructure 102.1 can also be designed as a seat shell. The seat substructure 102.1 is fastened to the longitudinal adjustment unit 110, in particular to the movable upper rail 114.

The conventional seat device 118 is disposed on the seat part 102 so as to support a leg, in particular a femur, of a user of the vehicle 100, while forming a front end of the seat part 102.

Moreover, the seat part 102 can comprise an upholstery unit and/or a seat cover, which are not illustrated and are fastened to the seat substructure 102.1 in a way not illustrated in more detail.

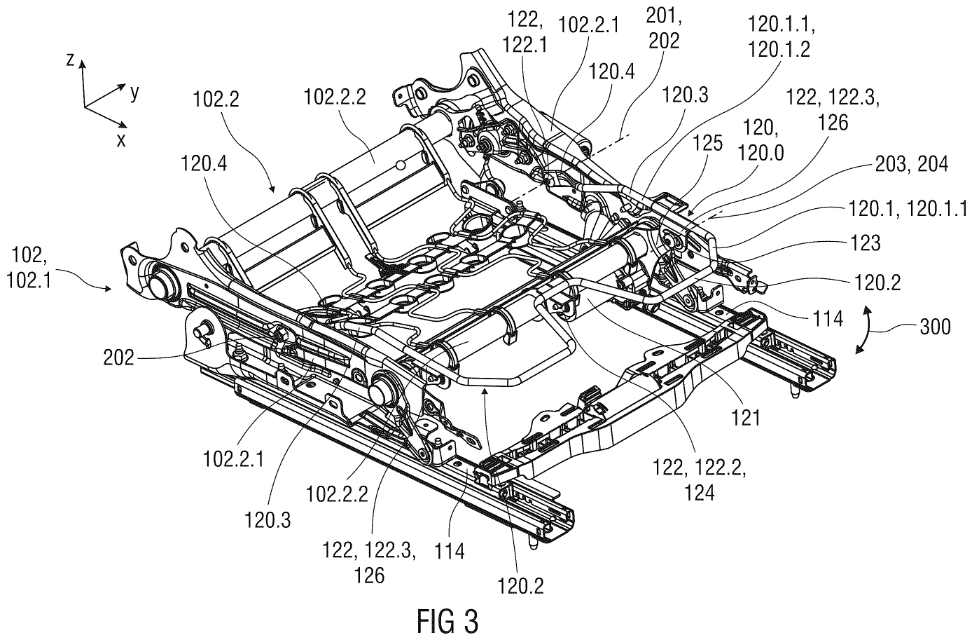

FIGS. 3 to 6 show a first example of a support inclination device 120 according to the invention (also referred to as support device or inclination device for short).

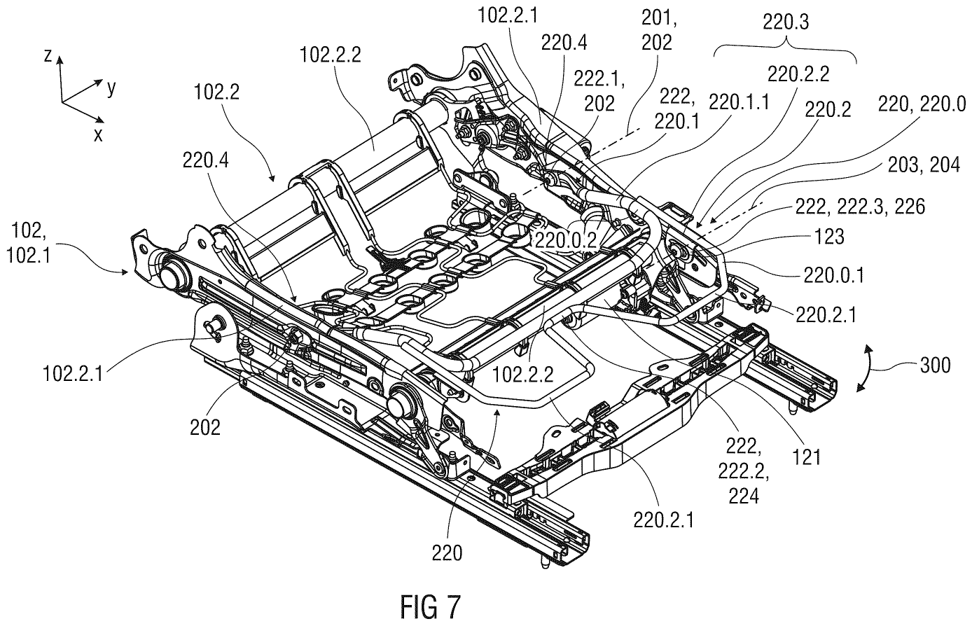

FIGS. 7 to 11 show a second example of a support inclination device 220 according to the invention (also referred to as support device or inclination device for short). The support inclination devices 120, 220 according to the invention are in each case able to be fastened, or are fastened, to a seat part 102. In terms of construction and functions, the seat part 102 illustrated in FIG. 2 and in FIGS. 3 to 6 corresponds to the seat part 102 illustrated in FIGS. 7 to 11.

The seat part 102 comprises the seat frame 102.2 which comprises, for example, two frame sides 102.2.1 and two crossbars 102.2.2 connecting the latter. The seat frame 102.2 forms the supporting structure of the seat part 102. The seat frame 102.2, by way of its frame sides 102.2.1, is on both sides fastened to the respective upper rail 114.

To this extent, the description of the seat part 102 applies to all support inclination devices 118, 120 and 220.

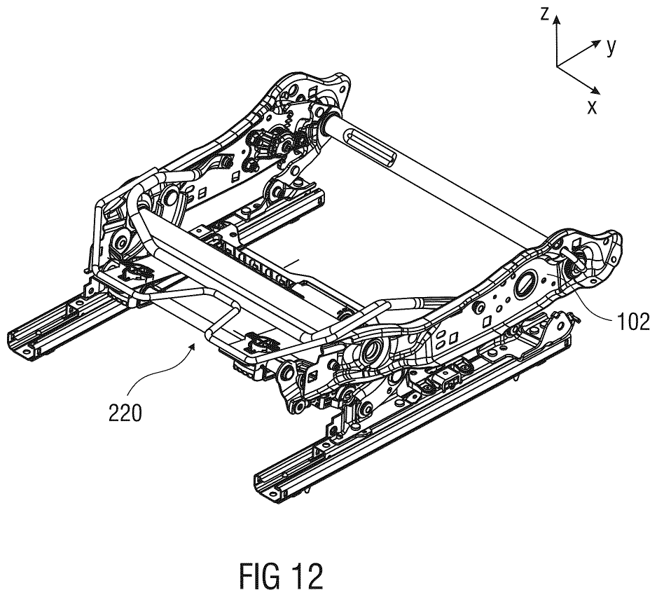

In principle, the support inclination devices 120, 220 according to the invention can also be combined with other seat parts 102 known in the prior art, as is shown in FIG. 12.

The seat inclination devices 120, 220 according to the invention are in each case designed as a driven inclination support 120.0, 220.0 (illustrated in FIGS. 3 and 7), which is articulated so as to be adjustable for inclination on the seat part 102, in particular the seat frames 102.2 (also referred to as seat substructure).

For this purpose, the respective support inclination device 120, 220 comprises a drive unit 121 and a support 120.1, 220.1 which is bent multiple times and is designed as an inclination support 120.0, 220.0, the latter being on one side rotatably mounted without play and being on the other side rotatably mounted with play 123 on a bracket 125 and by way of the bracket 125 being coupled to the drive unit 121 for inclination adjustment.

The respective support 120.1, 220.1 is on one side mounted so as to be rotatable without play about a first rotation axis 201, which in particular forms a rear center of rotation 202, and is on the other side mounted on the bracket 125 with the play 123 so as to be rotatable about a second rotation axis 203, which in particular forms a front center of rotation 204, and by way of the bracket 125 is coupled to the drive unit 121 for inclination adjustment.

The support 120.1, 220.1, designed as an inclination support 120.0, 220.0, is in particular mounted on the bracket 125 so as to be, by way of the play 123, longitudinally movable in a restricted manner, in particular movable in the longitudinal direction x in a restricted manner. The respective inclination support 120.0, 220.0 is moreover designed to be movable in at least one additional spatial direction, preferably about a transverse axis, in the vertical direction z, while driven by the drive unit 121. The respective inclination support 120.0, 220.0 is, for example, adjustable for inclination by a predefined inclination angle in a range from 0° to 10°, for example more than 0° to less than 5°, in particular of more than 0° to less than 3°, relative to a horizontal, according to the arrow 300 (illustrated in FIGS. 3 and 7).

FIG. 3 shows the seat part 102 with a support inclination device 120 according to the invention, and according to a first exemplary embodiment, hereunder referred to as first support inclination device 120, in a perspective illustration.

The first support inclination device 120 comprises as an inclination support 120.0 a multi-bend support 120.1, for example, in particular a wire multi-bend support 120.1.1 or a tubular multi-bend support 120.1.2.

In particular, the support 120.1 is designed to be flexible and/or rotatable in at least one spatial direction, in particular in the vertical direction z, according to the arrow 300. This simply enables an integrated tilting function or an integrated inclining function for the first support inclination device 120 without additional adjustment elements. In other words: the first support inclination device 120 is designed as an inclination support 120.0 driven by the drive unit 121.

The support 120.1 is in particular designed as a wire multi-bend support 120.1.1. The support 120.1 is in particular designed integrally as a continuous, multi-bend wire. Alternatively, the support 120.1 can be designed as a tubular multi-bend support 120.1.2.

The support 120.1 is of a particularly simple construction and has a sufficient stiffness for a support, for example a leg support or thigh support of a user of the vehicle seat 100 (illustrated in FIG. 1).

The support 120.1 can have several interfaces 122 with the seat part 102, in particular with the seat substructure 102.1, with a seat cushion and/or with a seat cover of the vehicle seat 100.

For example, as a first interface 1221, the support 120.1 can have a rear center of rotation 202 about which the support 120.1 is movable, in particular rotatable, up and down relative to the seat substructure 102.1, according to the arrow 300.

The support 120.1 can comprise a second interface 122.2 as a front fastening 124 by which the support 120.1 is mounted so as to be movable in the longitudinal direction x, and/or in the vertical direction z, while compensating for tolerances, in particular while compensating for the play 123.

Moreover, the support 120.1 can comprise two third interfaces 122.3 as lateral fastenings 126 by which the support 120.1 is mounted so as to be movable in the longitudinal direction x, and/or in the vertical direction z, while compensating for tolerances.

The support 120.1 is designed in one plane, for example. The support 120.1 is in particular designed to be two-dimensional, for example as a two-dimensional tubular support 120.1.2 or a two-dimensional wire support 120.1.1.

The multi-bend support 120.1 can be produced in a simple and cost-effective manner, for example by a bending method, in particular a so-called CND bending method for tubes or wires.

For example, the support 120.1 has two U-shaped bent support portions 120.2, in particular front support portions 120.2, which serve to support the legs of the user. The respective outer legs 120.3 of the two U-shaped bent front support portions 120.2 are extended in length in the longitudinal direction x. Their free ends 120.4 form in each case the center of rotation 202.

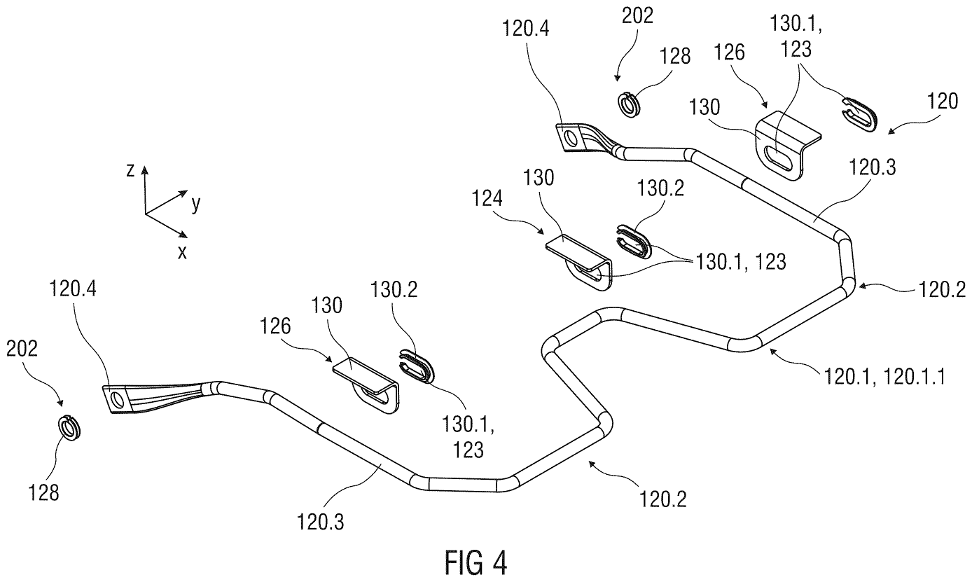

FIG. 4, in an exploded illustration, shows the first support inclination device 120 comprising the support 120.1 as inclination support 120.0, and the front fastening 124 as well as the lateral fastenings 126 and the rear centers of rotation 202.

For example, the rear centers of rotation 2202 are formed by bearing bushes 128 which are mounted on the seat part 102 so as to be movable about bearing pins or bearing bolts (illustrated in FIG. 3). As an alternative to the bearing bushes 128, bearing pins or bearing bolts which are rotatably mounted in corresponding bushes in the seat part 102 can be provided.

The front fastening 124 and/or the lateral fastenings 126 can be designed to be integral or in multiple parts. The front fastening 124 and/or the lateral fastenings 126 can in each case be fastened to the seat part 102 by way of a bearing plate 130, for example. For tolerance compensation, the respective bearing plate 130 can be provided with a corresponding recess 130.1, in particular a slot. Additionally a washer 130.2 with a corresponding recess 130.1 can be provided. The recess 130.1 forms the play 123.

The support 120.1 is designed to be two-dimensional and integral, with an integrated tilting function. The support 120.1 is in particular designed as an integral two-dimensional wire bent multiple times in one plane (also referred to as wire support 120.1.1) or as an integral two-dimensional tube bent multiple times in one plane (also referred to as tubular support 120.1.2).

The free ends 120.4 are expanded and designed in a planar manner in relation to the U-shaped bent support portions 120.2 and the outer legs 120.3. The U-shaped bent support portions 120.2 and the outer legs 120.3 are in particular designed to be circular in cross section.

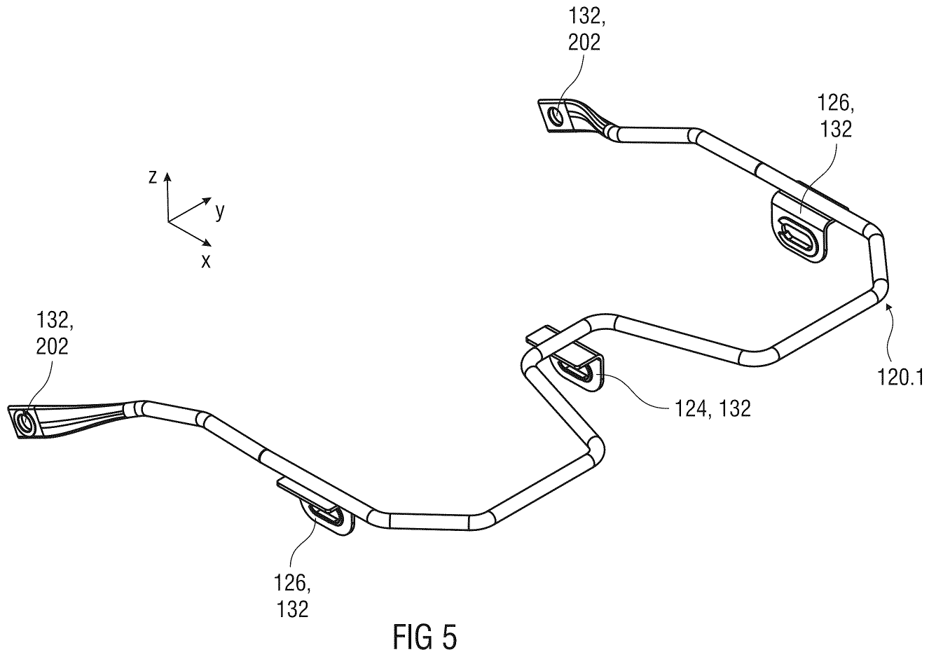

FIG. 5 shows in a perspective illustration the support 120.1 with assembled attachment parts 132, the latter forming, for example, the front fastening 124, the lateral fastenings 126 and/or the rear center of rotation 202.

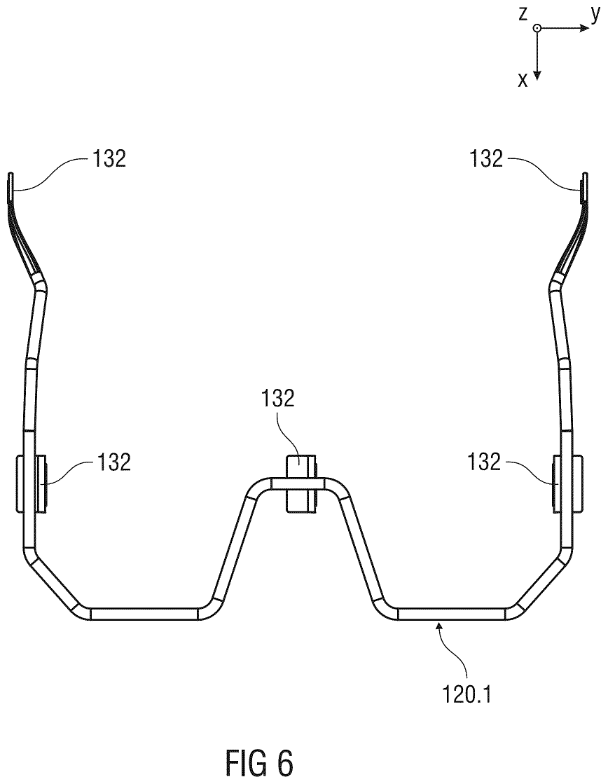

FIG. 6 shows the support 120.1 with the attachment parts 132 according to FIG. 5, in top view.

FIG. 7 shows in a perspective illustration the seat part 102 with the further support inclination device 220 according to the invention, and according to a second exemplary embodiment, hereunder referred to as second support inclination device 220.

In comparison to the first support inclination device 120, the second support inclination device 220 according to FIGS. 7 to 11 is designed in multiple parts, in particular two parts.

The second support inclination device 220 is designed as an inclination support 220.0 and comprises a first sub-support 220.1 and a second sub-support 220.2.

The inclination support 220.0 is designed in a manner analogous to the inclination support 120.0, as a wire multi-bend support 220.01 and/or as a tubular multi-bend support 220.0.2.

The first sub-support 220.1 is bent in a U-shape and, in a manner analogous to the first support inclination device 120, has two free ends 220.4 which form in each case the rear center of rotation 202. The first sub-support 220.1 is designed as a U-shaped bent wire or a U-shaped bent tube.

The second sub-support 220.2 is bent in a U-shape multiple times and, in a manner analogous to the first support inclination device 120, has two U-shaped bent support portions 220.21 (also referred to as front support portion 220.2.1), which form a front end of the seat part 102.

Respective outer legs 220.1.1, 220.2.2 of the two sub-supports 220.1, 220.2 are fixedly connected to one another and conjointly form the outer legs 220.3 of the second support inclination device 220.

The two sub-supports 220.1, 220.2, in a manner analogous to the support 120.1, are fastened to the seat part 102 by way interfaces 222, are mounted so as to be movable in a restricted manner while compensating for tolerances. The two sub-supports 220.1 and 220.2 are fixedly connected to one another and mounted so as to be rotatable conjointly about the rear centers of rotation 202, according to the arrow 300. In other words: the second support inclination device 220 is designed as an inclination support 220.0.

For example, the first sub-support 220.1 can have the rear center of rotation 202 as a first interface 222.1, about which the two fixedly interconnected sub-supports 220.1, 220.2 are movable, in particular rotatable, up and down relative to the seat substructure 102.1, according to the arrow 300.

The first sub-support 220.1 and the second sub-support 220.2 can be fixedly connected, in particular welded, to one another at a second interface 222.2, and form a front fastening 224. As a result, separate fastening elements can be dispensed with.

Moreover, the second sub-support 220.2 can comprise two third interfaces 222.3 as lateral fastenings 226 by way of which the two fixedly interconnected sub-supports 220.1, 220.2 are mounted so as to be movable in the longitudinal direction x, and/or in the vertical direction z, while compensating for tolerances, in particular while compensating for the play 123.

For example, the two sub-supports 220.1, 220.2 are formed in one plane. The two sub-supports 220.1, 220.2 are in particular designed to be two-dimensional, for example in each case as a two-dimensional multi-bend tube or a two-dimensional multi-bend wire.

The multi-bend sub-supports 220.1, 220.2 can be produced in a simple and cost-effective manner, for example by a bending method, in particular a so-called CNC bending method for tubes or wires.

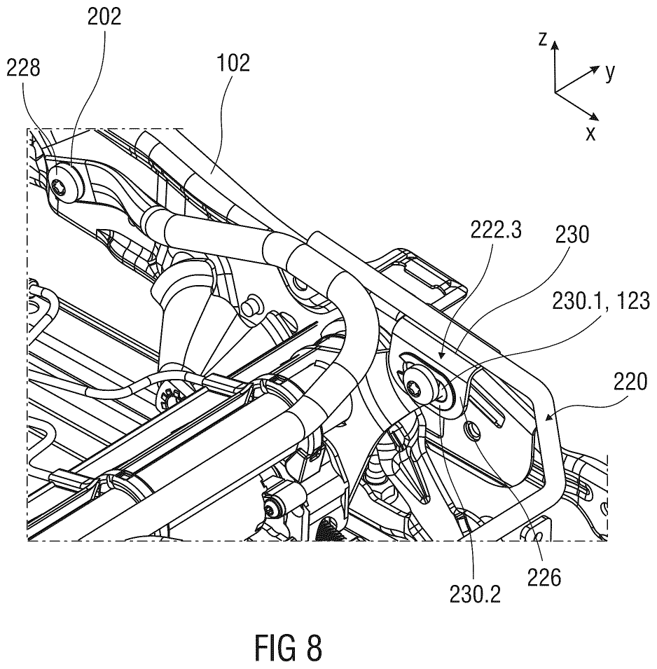

FIG. 8 shows an enlarged illustration of one of the third interfaces 222.3 of the second support inclination device 220 according to FIG. 7 on the seat part 102.

The associated lateral fastening 226 at the respective third interface 222.3 can be designed to be integral or in multiple parts. For example, the lateral fastening 226 can be fastened to the seat part 102 by way of a bearing plate 230. For tolerance compensation, the respective bearing plate 230 can be provided with a corresponding recess 230.1, in particular a slot. The recess 230.1 forms the play 123. Optionally, a washer 230.2 with a corresponding recess 230.1 can be provided.

The respective rear center of rotation 202 can be formed, for example, by a bearing bolt 228 which is rotatably mounted in a corresponding bush in the seat part 102. Alternatively, instead of the bearing bolt 228, a corresponding bush can be provided, in which a bearing pin or a bolt is then movably mounted on the seat part 102.

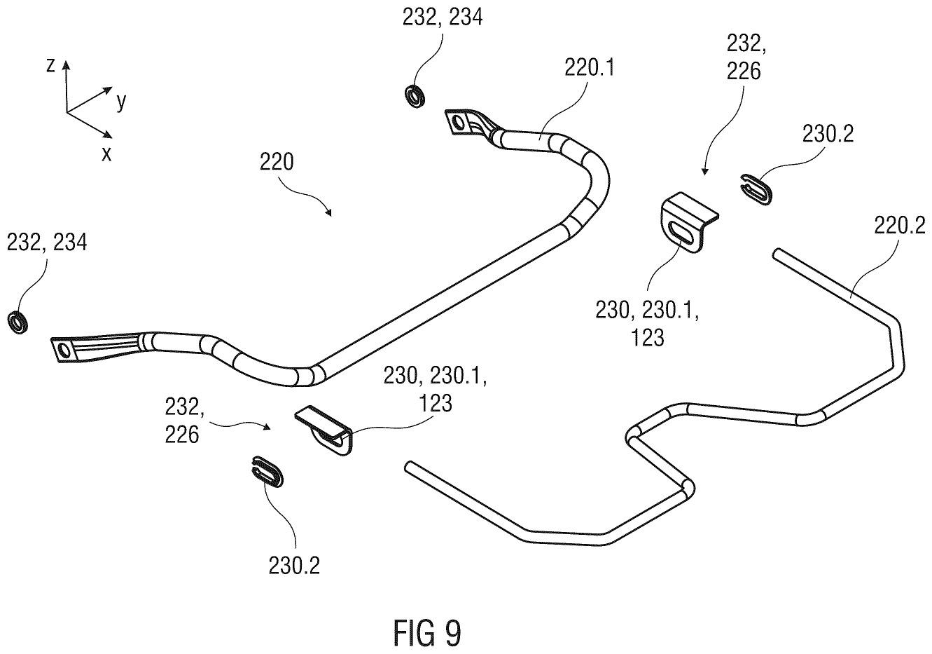

FIG. 9 shows in an exploded illustration the second support inclination device 220 according to the second exemplary embodiment. The support inclination device 220 comprises the two sub-supports 220.1, 220.2, each designed as integral multi-bend wires or integral multi-bend tubes, and the lateral fastenings 226 and the bearing bushes 234 as attachment parts 232.

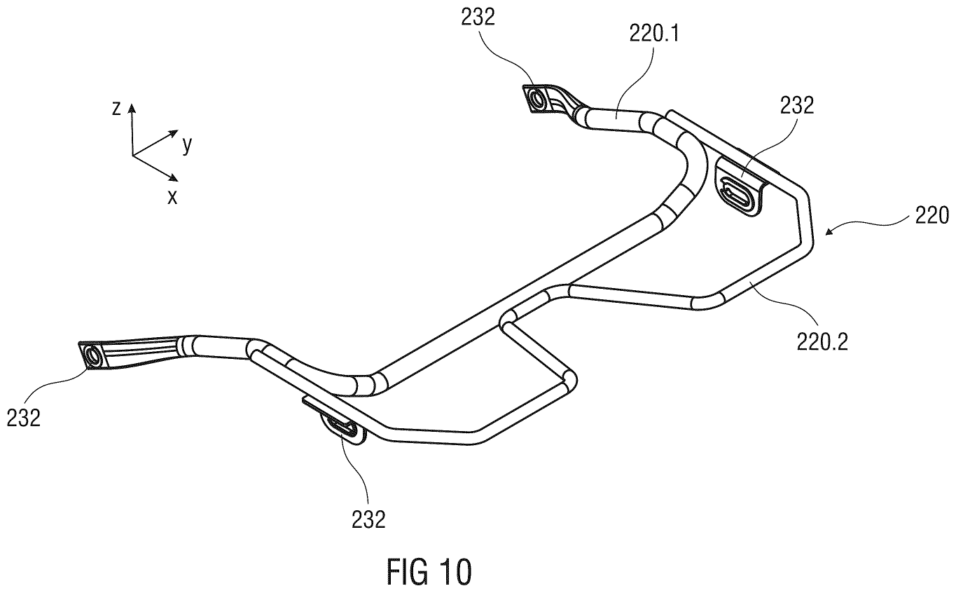

FIG. 10 shows in a perspective illustration the second support inclination device 220 according to the second exemplary embodiment with the fixedly interconnected sub-supports 220.1, 220.2 and with the attachment parts 232 assembled thereon. The attachment parts 232 are joined to the sub-supports 220.1, 220.2 in a materially integral manner, in particular welded thereto. The two sub-supports 220.1, 220.2 are fixedly connected to one another both laterally as well as centrically, in particular joined to one another in a materially integral manner, for example welded.

The sub-supports 220.1 and 220.2 are in each case designed as an integral multi-bend tubular profile or as an integral multi-bend wire.

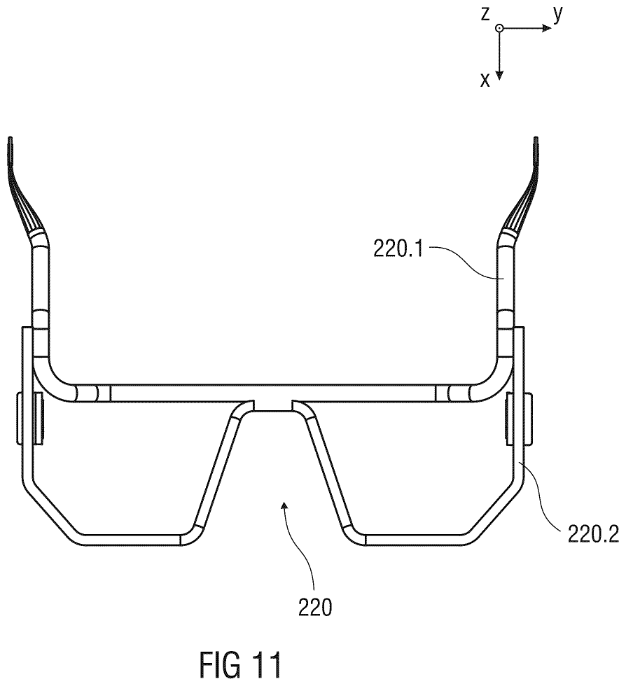

FIG. 11 shows the second support inclination device 220 according to FIG. 10, designed in two parts from the two fixedly interconnected sub-supports 220.1, 220.2, in top view.

FIG. 12 shows in a perspective illustration the second support inclination device 220 according to the second exemplary embodiment, assembled on another seat part 102.

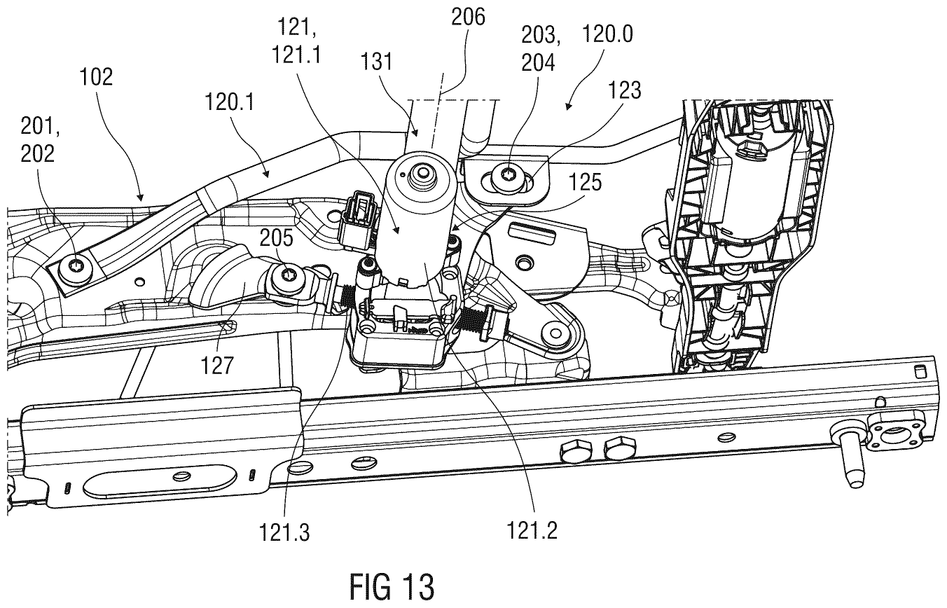

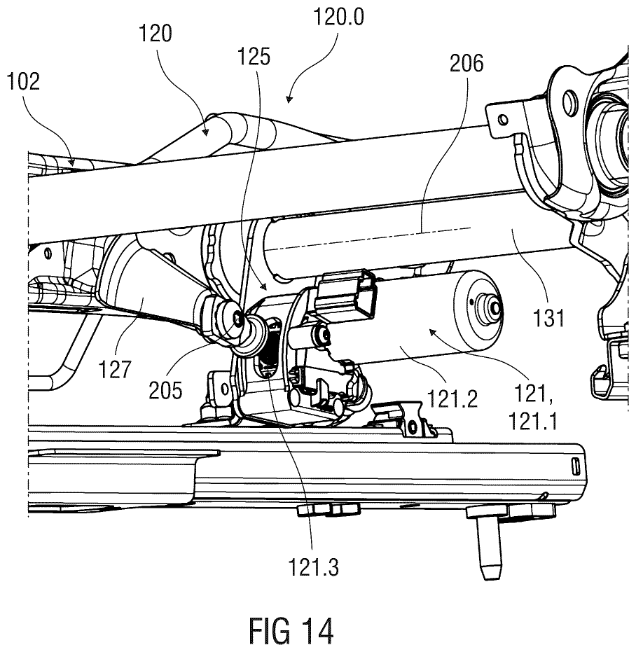

FIGS. 13 and 14 show in each case an enlarged fragment of the support inclination device 120 in the region of the drive unit 121. The region of the drive unit 121 of the support inclination device 220 is of analogous construction.

The drive unit 121 is in particular designed as a linear drive 121.1, for example a spindle drive. For example, the linear drive 121.1 comprises a motor 121.2 and a spindle 121.3. The spindle 121.3 is mounted on the seat part 102, in particular on a holder 127 which is fixedly connected, in particular welded, to the seat part 102, so as to be rotatable about a third rotation axis 205. The motor 121.2 is fastened to the bracket 125 which in turn is fixedly connected, in particular welded, to a transmission element 131 which is mounted on the seat part 102 so as to be rotatable about a fourth rotation axis 206.

The second rotation axis 203, in particular the front center of rotation 204, has the play 123 in the longitudinal direction x in order to enable relative movements and/or compensate for tolerances (only illustrated in FIG. 13, obscured by the transmission element 131 in FIG. 14).

Summarizing, the respective inclination support 120.0, 220.0 is of a multi-bend design and, driven by the drive unit 121, adjustable in terms of its inclination. Additionally, the respective inclination support 120.0, 220.0 is on one side mounted at the rear center of rotation 202 so as to be rotatable about the first rotation axis 201 without play, and on the other side mounted at the front center of rotation 204 so as to be rotatable about the second rotation axis 203 and with the play 123 on the bracket 125 and by way of the bracket 125 coupled to the drive unit 121 for inclination adjustment.

The support inclination devices 120 and 220 according to the invention described herein, which are designed as inclination supports 120.0, 220.0, due to their simple construction can be combined in an arbitrary manner with other seat parts 102.

### LIST OF REFERENCE SIGNS

100 Vehicle seat
102 Seat part
102.1 Seat substructure
102.2 Seat frame
102.2.1 Frame side
102.2.2 Crossbar
104 Backrest
106 Fitting
108 Rotation axis
110 Longitudinal adjustment unit
112 Rail assembly
114 First rail element (upper rail)
116 Second rail element (lower rail)
118 Conventional support device
118.1 Support shell
120 Support inclination device (first exemplary embodiment), first support inclination device
120.0 Inclination support
120.1 Support
120.1.1 Wire support
120.1.2 Tubular support
120.2 U-shaped bent/front support portion
120.3 Outer leg
120.4 Free end
121 Drive unit
121.1 Linear drive
121.2 Motor
121.3 Spindle
122 Interface
122.1 First interface
122.2 Second interface
122.3 Third interface
123 Play
124 Front fastening
125 Bracket
126 Lateral fastening
127 Holder
128 Bearing bush
130 Bearing plate
130.1 Recess
130.2 Washer
131 Transmission element
132 Attachment part
200 Center of rotation
201 First rotation axis
202 Rear center of rotation
203 Second rotation axis
204 Front center of rotation
205 Third rotation axis
206 Fourth rotation axis
220 Support inclination device (second exemplary embodiment), second support inclination device
220.0 Inclination support
220.0.1 Wire support
220.0.2 Tubular support
220.1 First sub-support
220.1.1 Outer leg
220.2 Second sub-support
220.2.1 U-shaped bent support portion
220.2.2 Outer leg
220.3 Outer legs
220.4 Free end
222 Interface
222.1 First interface
222.2 Second interface
222.3 Third interface
224 Front fastening
226 Lateral fastening
228 Bearing bolt
230 Bearing plate
230.1 Recess
230.2 Washer
232 Attachment part
234 Bearing bush
300 Arrow
x Longitudinal direction
y Transverse direction
z Vertical direction

What is claimed is

1. A support inclination device for a seat face of a vehicle seat, comprising: a drive unit and a support which is bent multiple times and is designed as an inclination support, the latter on one side being rotatably mounted without play, and on the other side being rotatably mounted with play on a bracket and by way of the bracket being coupled to the drive unit for inclination adjustment.

2. The support inclination device as claimed in claim 1, wherein the inclination support is mounted on the bracket so as to be longitudinally movable in a restricted manner by the play.

3. The support inclination device as claimed in claim 1, wherein the inclination support in terms of inclination is adjustable by a predefined inclination angle in a range from 0° to 10° relative to a horizontal.

4. The support inclination device as claimed in claim 1, wherein the inclination support is designed as a wire support which is formed from at least one bent wire material or one bent strip material.

5. The support inclination device as claimed in claim 1, wherein the inclination support is designed as a tubular support which is formed from at least one bent tubular material.

6. The support inclination device as claimed in claim 1, wherein the inclination support is of multi-part design.

7. The support inclination device as claimed in claim 1, wherein the inclination support is formed from a first bent sub-support and a second bent sub-support.

8. A seat part having a seat frame and fastened thereto a support inclination device as claimed in claim 1.

9. The seat part as claimed in claim 8, wherein the inclination support is disposed between two frame sides and is fastened thereto so as to be longitudinally movable in a restricted manner.

10. A vehicle seat having a seat part as claimed in claim 8.
